(19) United States
(12) Patent Application Publication
(10) Pub. No.: US 2025/0305626 A1
(43) Pub. Date: Oct. 2, 2025

(54) DEVICE FOR HOLDING UP UTENSILS FOR DAILY USE

(71) Applicant: Joan GOTZE, Holzminden (DE)

(72) Inventor: Joan GOTZE, Holzminden (DE)

(21) Appl. No.: 18/284,859

(22) PCT Filed: Mar. 28, 2021
(86) PCT No.: PCT/DE2021/000056

§ 371 Date: Feb. 25, 2024

(51) Int. Cl. F16M 11/38; A47L 9/00; B23K 26/38; F16M 11/04

(52) U.S. Cl. CPC F16M 11/38; A47L 9/0063; B23K 26/38; F16M 11/041

(57) ABSTRACT

A device (1) for supporting handles, rods, pipes or similar for utensils in the private or industrial field of use, for example in the home, in agriculture, in a workshop or on a road or on a building site. The device (1) consists in principle of two elements which are simple to produce, specifically a main element (2) and a support element (3), which are movably interconnected. The device (1) is detachably fastened by its main element (2) with the aid of a suitable fastening means to the handle to be supported or the pipe to be supported. When used to support the handle of a utensil, the support element (3) is pivoted out by a predefined angle α such that the foot (9) of the support element (3) comes to a stop on the ground at at least two points (13, 13′).

The present invention relates to a device and a method for manufacturing the device for supporting and facilitating the use of everyday implements, in particular a device which is attached to handles, pipes or the like of everyday implements, for which purpose a support element/swivel element is unfolded in order to hold a support for the handle or pipe of an implement in a predetermined upright position for a short time therewith. The device can be adjusted according to the specific needs of the user.

Such devices are known in the prior art from DE195 40 862 C2. This publication discloses a hinged holding device for the suction tube of hoovers on and for household or garden appliances, which has a tube or handle. This foldable holding device essentially comprises a clamp to which two foldable arms are hinged, the longitudinal axis of which forms an adjustable angle with the longitudinal axis of the handle of the appliance to which the clamp is attached, in order to hold the handle or tube in a certain inclined position.

In another disclosure document DE 32 42 429 A1, a holding arrangement for a hoover rod is also disclosed, in which two support rods are also movably attached with a clamp, whereby the angle of spread of the support rods can be adjusted with the aid of a guide rail.

A disadvantage of this device is that the fastening means or the clamp with which the two swiveling holder feet are fastened to the handle or the pipe of the hoover develop too great a mechanical load at certain points, so that the surface of the object to be fastened can easily be damaged. Another disadvantage is that the construction of the device as a whole is technically relatively complex and therefore also cost-intensive to manufacture.

Therefore, it is the task of the present invention to provide a device that overcomes the disadvantages in the prior art and is simple and inexpensive to manufacture.

This task is solved with the characterising features of the main claims.

Starting from the state of the art set out above, the device according to the invention for supporting handles, pipes or the like for implements in everyday use, for example brooms, hoover pipes, shovels or the like, is characterised in that a one-piece support element/swivel element is movably arranged on a base element, the one-piece swivel element having means suitable for giving the device a self-retaining stability, such as, for example, a foot element which increases the bearing surface of the support element.

An advantage is seen in the fact that the basic element is elongated and has at least one groove-like cross-sectional shape, for example round, curved, triangular or trapezoidal.

A further advantage is seen in the fact that at least one means, for example a joint, is arranged on the base element, which serves for the movable steering of the support element to the base element.

Furthermore, it is advantageous that at least one bend is arranged along the longitudinal axis of the support element in the upper end region of the support element, with which the swivel range of the support element is defined or limited. For this purpose, it is advantageous that a limiting element is arranged in the end region of the support element, which limits or defines the swivel range of the support element.

Furthermore, it is advantageous that the at least one bend on the support element includes a predetermined angle α to the centreline of the elongated support element.

It is also advantageous that the support element is movably fastened to the base element by means of a hinge-like fastening element, wherein the hinge-like fastening element is arranged in the area of a bend of the support element.

Another advantage is seen in the fact that the one-piece support element is made of a relatively rigid material, for example steel, aluminium or plastic or wood.

A further advantage is seen in the fact that one end of the support element is formed enlarged in order to increase the stability in use of the assembled device.

Furthermore, it is advantageous that a retaining element, for example a magnet or a latching element or the like, is arranged on the base element and/or on the support element in order to hold the support element easily detachably on the base element.

It is further considered advantageous that at least one fastening and/or support element is arranged in the groove-like cross-sectional shape of the basic element, which is designed, for example, as a Velcro fastener or as a foam part or as an adhesive tape.

It is also advantageous that the basic element is fastened to handles, pipes or the like of the equipment to be supported in the household, yard and garden with the aid of an easily detachable fastening element, whereby the fastening element can be designed, for example, as a clamp or reusable plastic strap.

The method according to the invention for manufacturing a device for supporting stems, rods, pipes or the like for appliances in the private or commercial field of application, for example in the house, in the yard, in the workshop or on the street or on building sites, is characterised by the fact that a moulded basic element with at least one groove-shaped recess is movably arranged a one-piece supporting element/swivel element. It is advantageous that the pivoting range of the support element is limited by suitable means, for example by a bent limiting element arranged at one end of the support element.

It is also advantageous that at least the base element and/or the support element is produced by means of laser technology, for example by cutting the support element and/or the base element out of a flat sheet, wherein in a 1st process step the one-piece element is cut out of the flat sheet and then the one-piece part is subjected to a deformation, wherein the deformation can be a cold or hot deformation.

Further advantageous properties and features of the invention can be found in the subclaims and the description.

In the following, the invention is described in more detail with reference to drawings. It shows:

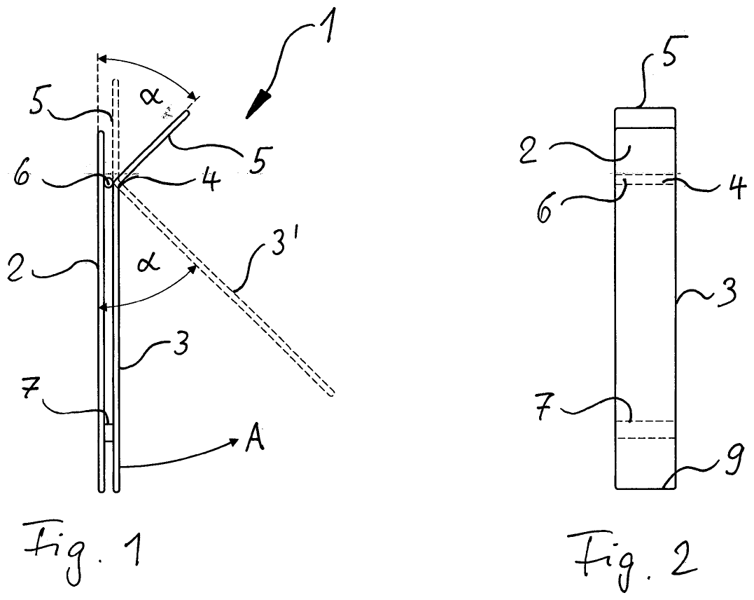

FIG. 1 a schematic side view of the device (1) with a base element (2) and a support element/swivel element (3) that is movably arranged on the base element (2);

FIG. 2 a schematic front view of the device (1), which has been swiveled by 90° in relation to the side view in FIG. 1;

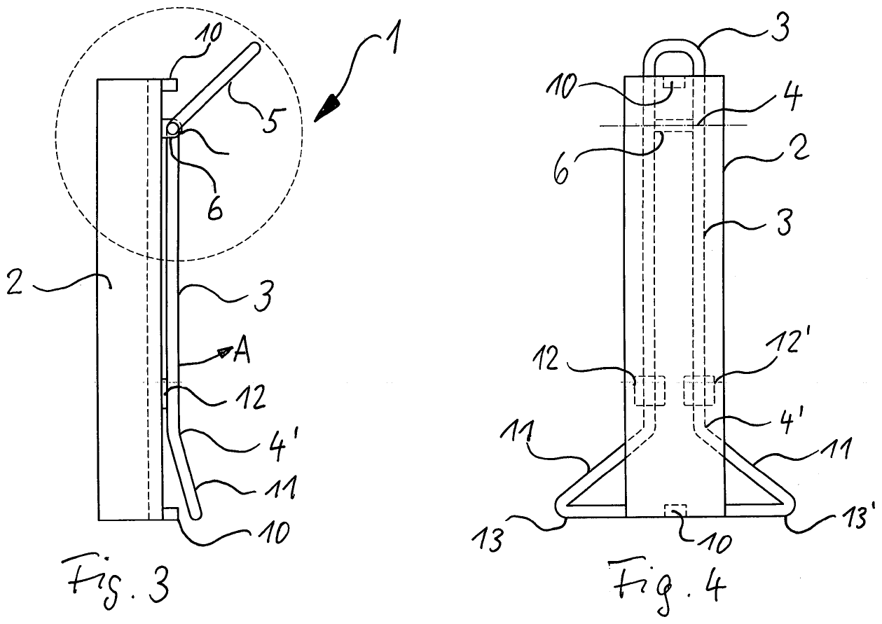

FIG. 3 a schematic side view of an embodiment of the device (1) according to the invention, in which a support element/swivel element (3) is movably attached to the base element (2) with an articulated means (6), for example a joint;

FIG. 4 a schematic front view of the device (1) swiveled by 90° in relation to the side view in FIG. 3;

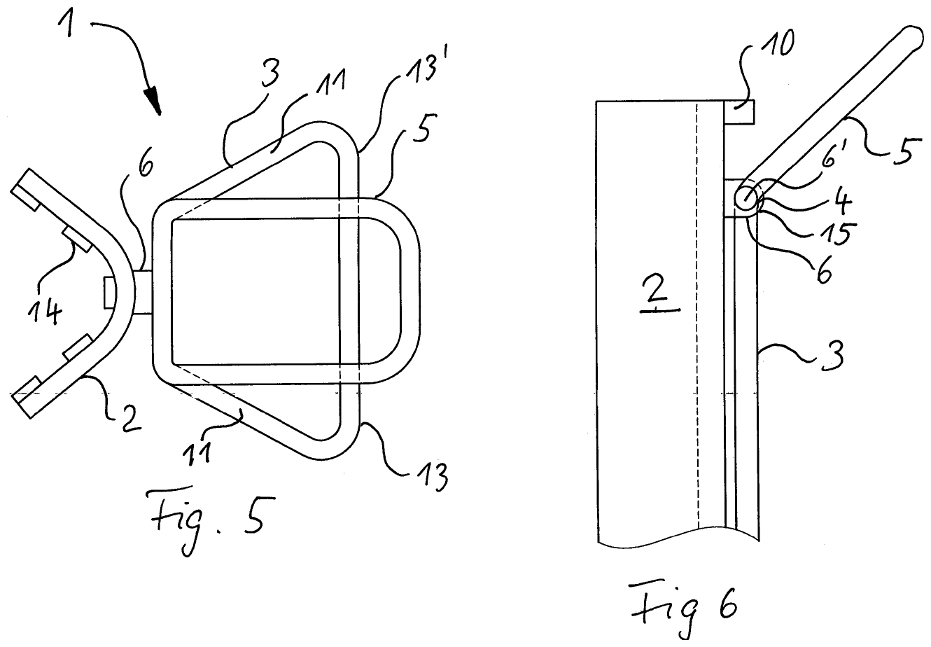

FIG. 5 a schematic top view of the device (1);

FIG. 6 a schematic enlarged view of the upper part of the device (1) from FIG. 3.

FIG. 1 shows a schematic side view of the device 1, which essentially represents the principle of the device according to the invention and shows the device 1 once in the folded state and once in the unfolded state, which is symbolised by the dashed lines. The device consists essentially of the base element 2, to which a support element 3 is arranged. The device 1 serves to support a style or a tube (not shown here) of an implement in the household, yard, garden in private or commercial use during a break in work and to hold it in a predetermined position or attitude for a short time. The device 1 thus consists of two parts, the basic element 2 and the support element 3. The basic element 2 is a rod-like part which is shaped in its cross-sectional form, whereby the cross-sectional form can take on different shapes depending on the intended use, which is a question of the respective application. The cross-section can be either curved or round or triangular or polygonal. As a result of the shaping of the cross-section, the rod-like basic element 2 has a groove longitudinally, which is described in more detail below.

A support element 3 is arranged on the base element 2, which has a bend 4 in the upper part in this illustration, so that the upper leg 5 of the support element 3 encloses a defined fixed angle α with the longitudinal axis of the support element 3 and thus defines a swivel range of the support element 3. In the area of the bend 4 of the support element 3, a fastening element 6 is arranged that movably fastens the base element 2 to the support element 3. The dashed lines 3′, 5′ symbolise the support element 3 in the unfolded state, i.e., in other words the position that the support element 3 assumes when the handle or the tube of the respective implement in question is supported during a short break in work. In the folded state of the device 1, the lower leg of the support element 3 shown in this illustration lies parallel to the longitudinal axis of the base element 2 and is quickly and easily detachably secured in this position by means of a suitable retaining element 7. As a result of the rigid bending 4 by the angle α, the lower leg 3′ also assumes the angle α to the longitudinal axis of the base element 2 when the leg 5, i.e., the limiting element, comes to lie parallel to the longitudinal axis of the base element 2.

FIG. 2 shows a schematic front view of the device 1, which is swiveled 90° clockwise in relation to the side view in FIG. 1. In this representation it can be seen that the total length of the support element 3 is slightly greater than the total length of the base element 2, of which only the upper edge is shown in this representation. In the area of the bend 4 of the support element 3 the movable fastening element 6 is arranged, which in its simplest embodiment can be a swivel hinge. The embodiment of the foot 9 of the support element 3, which can assume different embodiments, is described in more detail below.

FIG. 3 shows a schematic side view of a conceivable embodiment example of the device 1, in which a support element 3 is hinged to the base element 2 with a suitable fastening means 6, whereby the suitable fastening element 6 can be, for example, a hinge. As already mentioned above, the base element 2 has a groove-like shape in cross-section which extends over the entire length of the base element 2. The cross-sectional shape can take on various forms, such as round or more angular, the purpose of this groove-like shape being that the base element 2 can fit against the outer shape of the object to be supported, for example a handle or a tube, in order to provide the device 1 with the greatest possible support. At the upper and lower ends of the base element 2, a projection 10 can be seen in each case, which serves to provide a certain hold for a fastening clip, which is not shown here, in order to secure the fit of the clip or fastener. In the upper region in this illustration of the base element 2, the support element 3 is rotatably hinged to the base element 2 by a joint 6. This allows the support element 3 to be pivoted within the angle α in the direction of the arrow A. The upper leg 5 of the support element 3 serves as a means for limiting the swiveling range of the support element 3. The swiveling range thus lies within the angle α which is to be set between 0° and 70°, preferably at 45°. In principle, another means of limiting the swivel range is also conceivable, for example a flexible element between the base element 2 and the support element 3, which has a certain length that defines the angle α. The support element 3 also has a further bend 4′ in the lower region, from where the foot 9 of the support element 3 is formed and delimits the region of the foot 9 of the support element 3 from the region of the support element above it. The angle at which the foot 9, or its formation 11 of the support element 3, is bent is smaller than the angle α at which the limiting element 5 is angled. In this embodiment, a releasable retaining element 12, 12′ is suitably arranged to retain the support element 3 in the folded state of the device 1. This retaining element 12 may be a permanent magnet which attracts and easily releasably retains a ferromagnetic counterpart, the ferromagnetic counterpart being part of the support element. The same function would also be fulfilled, for example, by a mechanical click fastener in which a latching lug engages in a receiving element.

FIG. 4 shows a schematic front view of the device 1, rotated 90° clockwise in relation to FIG. 3. It can be seen from this representation that the support element 3 is designed as an annular closed element 3, the lower part of which in this representation is designed to be flared, which ensures a high degree of stability of the device 1 in the unfolded state. The foot end in this embodiment is triangular in shape, but this also implies that the foot can take any other shape, the important thing being that the foot has at least two support points 13, 13′ which come to rest on the ground in use. In the upper region of this embodiment, the support element 3 has an arcuate shape, so that the support element 3 as a whole assumes a one-piece and annular, continuous shape, which is an advantageous configuration, in particular for the manufacturing process of the support element. Thus, the support element 3 can be manufactured from a wire, for example, which only has to be joined together at one point. A comparably equivalent manufacturing of the support element 3 and also of the base element 2 is seen in the fact that the two parts are cut out of a flat metal sheet by means of a suitable laser technique, whereby in particular the weight of the base element 2 can be considerably reduced. As already mentioned, the projections 10 at the upper and lower ends of the base element 2 serve to secure a fastener to be selected (not shown here) so that it does not slip over the edge of the base element 2. Just above the bend 4′ of the base element 11 at least one retaining element 12, 12′ is arranged to hold the support element 3 in a releasable rest position. In the upper area of the support element 3, close to the bend 4, a fastening element 6 is arranged which is designed as a swivel joint.

FIG. 5 shows a schematic top view of the device 1. In this embodiment, the cross-section of the base element 2 is curved in an oval-like manner, which corresponds approximately to the curvature of a handle or a tube of the device to be supported. This cross-section can of course also have other shapes, for example triangular or polygonal, so that the shape of the base element 2 is optimally adapted to the shape of the style or the tube to which the base element 2 is to be attached. Adhesive elements 14 can also serve this purpose, which on the one hand treat the surface of the style or the tube (not shown here) gently and on the other hand can serve as a temporarily adhesive fastening means. The support element 3 is fastened to the base element 2 by an articulated fastening means 6. It can also be seen from this illustration that the support element 3 in this embodiment is of closed annular design, as already explained in more detail above.

FIG. 6 shows a section of a schematic enlarged view of the upper area of the device 1 from FIG. 3, in particular the area of a possible fastening element 6, with which the support element 3 is rotatably fastened to the base element 2. In the present embodiment example, the movable element is designed as a rotary hinge, wherein a rotary axis 6′ is enclosed by a ring element 15. The ring element 15 can have various embodiments, for example in the simplest case consisting of a metal belt surrounding the axis of rotation 6′ of the hinge. Another embodiment of the movable fastening element 6 can be seen in a flexible plastic part which is firmly connected to the base element 2 and the support element 3 in the area of the deposit 4 of the support element.

In summary, it may be stated that the present invention provides a device 1 for supporting handles, rods, pipes or the like for equipment used in the home or in a commercial application, for example in the house, in the yard, in the workshop or on the street or at a construction site. The device consists in principle of two elements that are easy to manufacture, namely a base element 2 and a support element 3, which are movably connected to each other. The device 1 is detachably or non-detachably attached by its base element 2 to the stem or pipe to be supported by means of a suitable fastening means. When used to support the handle of an implement, the support element 3 is swung out through a predetermined angle α so that the support element 3 comes to rest with its foot 9 on the ground at least two points 13,13′.

1. Device (1) for supporting rods, pipes or the like for implements in the household, yard and garden, for example for brooms, rakes, shovels or the like, characterised by a base element (2) to which a one-piece support element (3) is movably arranged.

2. Device according to claim 1, characterised in that the one-piece support element (3) comprises means (11) suitable for giving the device (1) an independent stability.

3. Device according to claim 1, characterised in that the basic element (2) is elongated and has at least one groove-like cross-sectional shape, for example round, curved, triangular, trapezoidal or polygonal.

4. Device according to claims 1 and 2, characterised in that at least one means (6), for example a joint, is arranged on the base element (2), which means serves for the movable articulation of the one-piece support element (3).

5. Device according to claim 1, characterised by at least one bend (4,4′) along the longitudinal axis of the support element (3), which is arranged in the end region of the support element (3).

6. Device according to claims 1 and 4, characterised in that the at least one bend (4, 4′) on the support element (3) has a predetermined angle α to the longitudinal axis of the pivot element (3). encloses.

7. Device according to one of the preceding claims, characterised in that the support element (3) is movably fastened to the base element (2) by means of a hinge-like fastening element (6), the hinge-like fastening element (6) being arranged in the region of a bend (4) of the support element (3).

8. A device according to any of the preceding claims, characterised in that the one-piece support element (3) is made of a relatively rigid material, for example steel, aluminium plastic or wood.

9. Device according to one of the preceding claims, characterised in that a limiting element (5) is arranged in the end region of the support element (3), which limits or defines the swiveling range of the support element (3).

10. Device according to one of the preceding claims, characterised in that one end of the support element (3) is enlarged in order to increase the stability of the assembled device (1).

11. Device according to one of the preceding claims, characterised in that a retaining element ( ), for example a magnet or a latching element or the like, is arranged on the base element (2) and/or on the support element (3) in order to hold the support element (3) easily detachably on the base element (2).

12. Device according to one of the preceding claims, characterized in that at least one adhesive and/or protective element (14) is arranged in the groove-like cross-sectional shape of the base element (2), which adhesive and/or protective element (14) is designed, for example, as a Velcro fastener part or foam part or adhesive tape.

13. Device according to any of the preceding claims, characterised in that the basic element (2) is attached to handles, pipes or the like of the household, yard and garden implements by means of an easily detachable fastening means and is designed, for example, as a clamp or reusable plastic strap.

14. Method of manufacturing a device (1) for supporting sticks, rods, pipes or the like for appliances in the private or commercial field of application, for example in the house, in the yard, in the workshop or on the street or on building sites, characterised in that an annular one-piece supporting element (3) is movably arranged on a shaped base element (2), the swiveling range of the supporting element (3) being limited by suitable means (5).

15. Method according to claim 14, characterised in that the suitable means (5) is realised, for example, with a bent limiting element (5) arranged at one end of the supporting/swiveling element (3).

16. Method according to claim 14, characterised in that at least the supporting element (3) and/or the base element (2) is produced by means of laser technology.
